(19) United States
(12) Patent Application Publication
(10) Pub. No.: US 2018/0112318 A1
(43) Pub. Date: Apr. 26, 2018

(54) CATALYST FOR GENERATING HYDROGEN AND METHOD OF PREPARING THE SAME

(71) Applicant: INDUSTRY-ACADEMIC COOPERATION FOUNDATION, YONSEI UNIVERSITY, Seoul (KR)

(72) Inventors: Hyung Jun KIM, Seoul (KR); Ju Sang PARK, Seoul (KR); Dong Hyun KIM, Anyang-si (KR)

(73) Assignee: INDUSTRY-ACADEMIC COOPERATION FOUNDATION, YONSEI UNIVERSITY, Seoul (KR)

(21) Appl. No.: 15/415,238

(22) Filed: Jan. 25, 2017

(30) Foreign Application Priority Data
Oct. 21, 2016 (KR) 10-2016-0137883

(51) Int. Cl. C25B 11/04; C01B 3/04; C25B 1/04

(52) U.S. Cl. CPC C25B 11/0405; C01B 3/042; C25B 1/04; C25B 11/0447; C25B 11/0426

(57) ABSTRACT

Disclosed are a catalyst for generating hydrogen and a method of preparing the same. The catalyst for generating hydrogen according to an embodiment of the present disclosure includes a conductive textile composed of a polymer fiber and a metal film, and a transition metal chalcogen compound thin film, wherein the surface of the polymer fiber is coated with the metal film and the transition metal chalcogen compound thin film is formed on the conductive textile. By combination of the transition metal chalcogen compound thin film and the conductive textile, the catalyst for generating hydrogen has excellent catalytic properties, such as low onset potential, small Tafel slope, high exchange current density and high stability.

### CROSS-REFERENCE TO RELATED APPLICATION

This application claims the priority benefit of Korean Patent Application No. 10-2016-0137883, filed on Oct. 21, 2016 in the Korean Intellectual Property Office, the disclosure of which is incorporated herein by reference.

### BACKGROUND OF THE DISCLOSURE

### Field of the Disclosure

The present disclosure relates to a catalyst for generating hydrogen and a method of preparing the same, and more particularly, to a catalyst for generating hydrogen in which a transition metal chalcogen compound thin film is formed on a conductive textile and a method of preparing the same.

### Description of the Related Art

In modern times, quality of life has continuously improved due to industrialization, but a rapid increase in energy use is making the problems of environmental pollution and resource depletion increasingly serious. To address environmental pollution and resource depletion, countries are focusing on clean fuel development. In particular, development of clean alternative energy using hydrogen as an energy source is attracting great attention.

Hydrogen has advantages as an energy source. Hydrogen is an abundant resource on the earth and is capable of producing a large amount of energy by reacting with oxygen while producing only water as a byproduct. Thus, by using hydrogen as an energy source, the problems of environmental pollution and resource depletion can be solved at the same time. In addition, hydrogen has a high energy density per unit mass and can be easily transformed into heat and electrochemical energy. Therefore, hydrogen may be the only alternative to overcome depletion of natural resources, global warming and environmental pollution caused by use of fossil fuels.

In order to operate a fuel cell using hydrogen as fuel, it is necessary to supply hydrogen smoothly. For this purpose, use of a hydrogen storage alloy, a hydrogen storage tank, a catalyst for generating hydrogen, and the like has been proposed.

In the case of the hydrogen storage alloy, limited storage capacity and durability deterioration are encountered, and the hydrogen storage tank is vulnerable to fire and explosion hazards. Accordingly, a method of supplying hydrogen using a catalyst for generating hydrogen which produces hydrogen on demand is attracting attention.

According to the method of supplying hydrogen using a catalyst for generating hydrogen, hydrogen is generated by reacting a catalyst for generating hydrogen, water, an acid solution, and alkaline water containing NaOH or KOH, or aqueous water. When a reaction for generating hydrogen using a catalyst is carried out, platinum, aluminum, magnesium, cobalt, nickel or an alloy thereof is used as a catalyst, and NaBH₄ or the like is used.

Disadvantages, however, are that the cost of a hydrogen production process increases due to the high price of materials, and risk of explosion when stored in the atmosphere increases, requiring an additional storage device.

### RELATED DOCUMENTS

### Patent Document

Korea Patent Publication No. 10-2011-0107378, “CATALYST FOR GENERATING HYDROGEN, METHOD OF GENERATING HYDROGEN AND HYDROGEN GENERATION APPARATUS”

Korea Patent No. 10-1389925, “NICKEL CATALYST FOR HYDROGEN GENERATION REACTION AND METHOD OF PREPARING THE SAME”

### SUMMARY OF THE DISCLOSURE

Therefore, the present disclosure has been made in view of the above problems, and it is an object of the present disclosure to provide a catalyst for generating hydrogen in which a transition metal chalcogen compound thin film is formed on a conductive textile and a method of preparing the same.

In accordance with the present disclosure, the above and other objects can be accomplished by the provision of a catalyst for generating hydrogen, including a conductive textile and a transition metal chalcogen compound thin film formed on the conductive textile, wherein the conductive textile is composed of a polymer fiber and a metal film, and the surface of the polymer fiber is coated with the metal film.

The polymer fiber may be at least any one selected from the group consisting of polyester, aramid, polystyrene, polyvinyl chloride, acrylonitrile-butadiene-styrene terpolymer, polyethylene, acrylic resin, nylon and polyacetal resin.

The metal film may include at least any one selected from the group consisting of nickel (Ni), copper (Cu), tin (Sn), gold (Au), silver (Ag), platinum (Pt), aluminum (Al), titanium (Ti), chromium (Cr), palladium (Pd), molybdenum (Mo), cobalt (Co), tungsten (W), iron (Fe) and zinc (Zn).

The transition metal chalcogen compound thin film may include cobalt sulfide (CoS).

In accordance with an aspect of the present disclosure, the above and other objects can be accomplished by the provision of a method of preparing a catalyst for generating hydrogen, the method including a step of preparing a conductive textile by coating the surface of a polymer fiber with a metal film and a step of forming a transition metal chalcogen compound thin film on the conductive textile using chalcogen and transition metal precursors.

The chalcogen precursor may include hydrogen sulfide (H₂S), and the transition metal precursor may include Co(AMD)₂(bis(N,N′-diisopropylacetamidinato) cobalt).

The transition metal chalcogen compound thin film may be formed by atomic layer deposition (ALD).

The transition metal chalcogen compound thin film may be formed at a temperature of 80 to 200° C.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a flowchart illustrating a method of preparing a catalyst for generating hydrogen according to an example of the present disclosure;

FIG. 2 is a graph showing the temperature-dependent growth rate of a catalyst for generating hydrogen according to an example of the present disclosure;

FIG. 3A is an image illustrating the shape of a catalyst for generating hydrogen according to an example of the present disclosure;

FIG. 3B is a drawing illustrating a three-dimensional catalyst for generating hydrogen according to an example of the present disclosure;

FIG. 3C is an image illustrating the cross section of a catalyst for generating hydrogen according to an example of the present disclosure;

FIG. 3D is an image illustrating a water-splitting reaction using a catalyst for generating hydrogen according to an example of the present disclosure;

FIGS. 4A to 4C are the images of a catalyst for generating hydrogen according to an example of the present disclosure obtained using a scanning electron microscope (SEM) and energy-dispersive X-ray spectroscopy (EDS); and

FIGS. 5A to 5C are graphs illustrating the catalytic characteristics of a catalyst for generating hydrogen according to an example of the present disclosure.

### DETAILED DESCRIPTION OF THE DISCLOSURE

The embodiments of the present disclosure are described with reference to the accompanying drawings and the description thereof, but are not limited thereto.

The terminology used in the present disclosure is for the purpose of describing particular embodiments only and is not intended to limit the disclosure. As used in the disclosure and the appended claims, the singular forms “a”, “an” and “the” are intended to include the plural forms as well, unless context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It should not be understood that arbitrary aspects or designs disclosed in “embodiments”, “examples”, “aspects”, etc. used in the specification are more satisfactory or advantageous than other aspects or designs.

In addition, the expression “or” means “inclusive or” rather than “exclusive or”. That is, unless otherwise mentioned or clearly inferred from context, the expression “x uses a or b” means any one of natural inclusive permutations.

Further, as used in the description of the disclosure and the appended claims, the singular forms “a”, “an” and “the” are intended to include the plural forms as well, unless context clearly indicates otherwise.

In addition, when an element such as a layer, a film, a region, and a constituent is referred to as being “on” another element, the element can be directly on another element or an intervening element can be present.

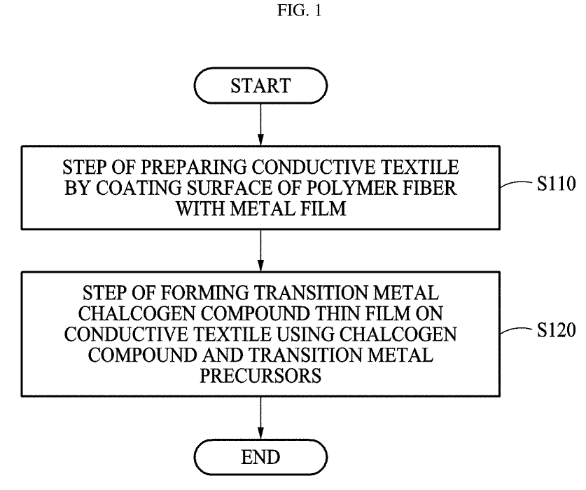

Hereinafter, referring to FIG. 1, a method of preparing a catalyst for generating hydrogen according to an embodiment of the present disclosure is described.

FIG. 1 is a flowchart illustrating the method of preparing a catalyst for generating hydrogen according to an embodiment of the present disclosure.

Referring to FIG. 1, the method of preparing a catalyst for generating hydrogen according to an embodiment of the present disclosure includes a step (S110) of preparing a conductive textile by coating the surface of a polymer fiber with a metal film and a step (S120) of forming a transition metal chalcogen compound thin film on the conductive textile using chalcogen and transition metal precursors.

In the step (S110) of preparing a conductive textile, a metal film may be formed on a polymer fiber by coating.

As the conductive textile, an electromagnetic wave shielding material, preferably an electromagnetic wave shielding material coated with a metal film acting as an electromagnetic wave shielding agent on a polymer fiber, may be used.

The polymer fiber may be at least any one selected from the group consisting of polyester, aramid, polystyrene, polyvinyl chloride, acrylonitrile-butadiene-styrene terpolymer, polyethylene, acrylic resin, nylon and polyacetal resin.

As the aramid polymer fiber, Kevlar or Nomex (DuPont, USA) may be used.

In addition, flexible polymeric materials may be used as the polymer fiber, and thus the catalyst for generating hydrogen according to an embodiment of the present disclosure may be applied to a flexible or wearable device.

For example, the catalyst for generating hydrogen of the present disclosure may be used as an energy source by installing a fabric-based catalyst for generating hydrogen in a net form to generate hydrogen at sea, or applying a catalyst for generating hydrogen to divers or submersibles,

The metal film may include at least any one selected from the group consisting of nickel (Ni), copper (Cu), tin (Sn), gold (Au), silver (Ag), platinum (Pt), aluminum (Al), titanium (Ti), chromium (Cr), palladium (Pd), molybdenum (Mo), cobalt (Co), tungsten (W), iron (Fe) and zinc (Zn).

The metal film may be formed using spin coating or physical vapor deposition. The spin coating is a process of forming a film with a liquid coating material spread by centrifugal force when applying a liquid coating material to a rotating substrate, and the physical vapor deposition is a process in which a film is formed on a substrate by target atoms that bounce off when target atoms collide with ionized atoms.

In particular, it is preferable to use spin coating from the viewpoint of cost because a thin film can be uniformly formed using a low-cost spin coating method.

Thus, the conductive textile may be obtained by coating the metal film on the polymer fiber.

Thereafter, the step (S120) of forming a transition metal chalcogen compound thin film on the conductive textile using chalcogen and transition metal precursors is executed.

The transition metal chalcogen compound thin film may include, but is not limited to, cobalt sulfide (CoS), and may include at least any one selected from the group consisting of molybdenum sulfide (MoS₂), tungsten sulfide (WS₂), niobium sulfide (NbS₂), vanadium sulfide (VS₂), nickel sulfide (NiS₂), molybdenum diselenide (MoSe₂), tungsten diselenide (WSe₂) and nickel diselenide (NiSe₂).

In addition, as the cobalt sulfide (CoS), a material having an atomic percent of cobalt (Co):sulfur (S) of 45:55 may be used.

The cobalt sulfide (CoS) has advantages such as good conductivity when used as the transition metal chalcogen compound thin film.

The transition metal chalcogen compound thin film may be formed using a gasified chalcogen precursor and by performing vapor deposition of a transition metal precursor.

Therefore, the transition metal chalcogen compound thin film may be formed on the conductive textile by a process of supplying and then reacting gasified transition metal and chalcogen precursors.

Preferably, according to an embodiment of the present disclosure, a transition metal chalcogen compound thin film of a predetermined thickness may be formed on the conductive textile by atomic layer deposition (ALD), which sequentially supplies chalcogen and transition metal precursors onto the conductive textile.

The chalcogen precursor may include, but is not limited to, hydrogen sulfide (H₂S), and may include at least any one selected from the group consisting of hydrogen sulfide (H₂S), sulfur powder, diethyl sulfide, dimethyl disulfide, ethyl methyl sulfide, (Et₃Si)₂S, selenium powder, hydrogen selenide (H₂Se), diethyl selenide, dimethyl diselenide, ethyl methyl selenide and (Et₃Si)₂Se.

The transition metal precursor may include, but is not limited to, Co(AMD)₂(bis(N,N′-diisopropylacetamidinato) cobalt), and may include at least any one selected from the group consisting of Co(AMD)₂, CoCl₂, CoCp(CO)₂, CoI₂, Co(acac)₂, CoCp₂, VCl₃, VoCl₃, NbCl₅, MoCl₅, Mo(CO)₆, WCl₆, WCl₄, WF₆, WOCl₄, NiCl₂, Ni(acac)₂ and NiCp₂.

The transition metal chalcogen compound thin film may be formed at a temperature of 80 to 200° C., preferably at a temperature of 80 to 100° C.

When the transition metal chalcogen compound thin film is formed at a temperature below 80° C., the transition metal chalcogen compound thin film is not uniformly formed on the conductive textile. On the other hand, when the transition metal chalcogen compound thin film is formed at a temperature above 200° C., the chalcogen and transition metal precursors are decomposed.

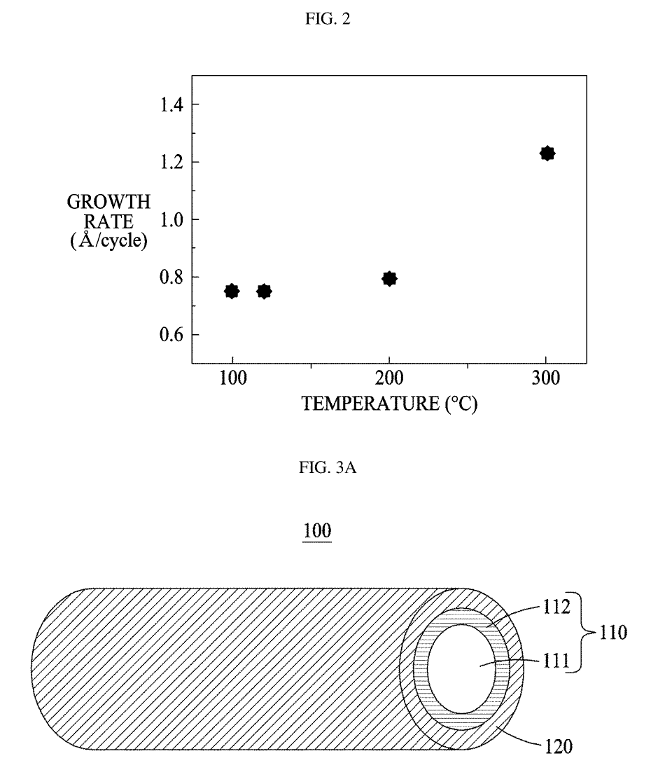

FIG. 2 is a graph showing the temperature-dependent growth rate of the catalyst for generating hydrogen according to an embodiment of the present disclosure.

Referring to FIG. 2, based on a result that a transition metal chalcogen compound thin film formed by atomic layer deposition exhibits a constant growth rate at 100 to 200° C., it can be seen that the transition metal chalcogen compound thin film according to an embodiment of the present disclosure is well formed.

Therefore, when the catalyst for generating hydrogen according to an embodiment of the present disclosure is prepared, a transition metal chalcogen compound thin film of an amorphous form may be formed by forming a transition metal chalcogen compound thin film on the conductive textile through a low-temperature synthesis process.

The thickness and number of the transition metal chalcogen compound thin film may be finely adjusted by controlling the formation temperature of the transition metal chalcogen compound thin film.

When atomic layer deposition is used, the thickness of a thin film increases in proportion to the number of cycles of atomic layer deposition. Thus, the thickness of the transition metal chalcogen compound thin film may be finely adjusted using atomic layer deposition.

In the catalyst for generating hydrogen according to an embodiment of the present disclosure, since the transition metal chalcogen compound thin film is formed on the conductive textile using atomic layer deposition, the thickness of the transition metal chalcogen compound thin film may be finely adjusted, and, consequently, the characteristics of the catalyst for generating hydrogen may be precisely analyzed.

In addition, in the catalyst for generating hydrogen according to an embodiment of the present disclosure, since the transition metal chalcogen compound thin film is formed on the conductive textile using atomic layer deposition, the transition metal chalcogen compound thin film may be uniformly formed over a large area, and, consequently, the amount of hydrogen generation may be increased due to an increase in a reaction zone for hydrogen generation reaction.

In addition, since the catalyst for generating hydrogen according to an embodiment of the present disclosure includes the conductive textile and the transition metal chalcogen compound thin film formed on the conductive textile, a Tafel slope is small, such that the activity of the catalyst is improved and, consequently, the stability of the catalyst may be improved.

Since the catalyst for generating hydrogen according to an embodiment of the present disclosure has a low onset potential, hydrogen generation reaction starts at low voltage, and, consequently, hydrogen may be generated at low electric power.

Since the catalyst for generating hydrogen according to an embodiment of the present disclosure has a high exchange current density, a large number of electrons is transferred, and, consequently, the amount of hydrogen generation may be increased.

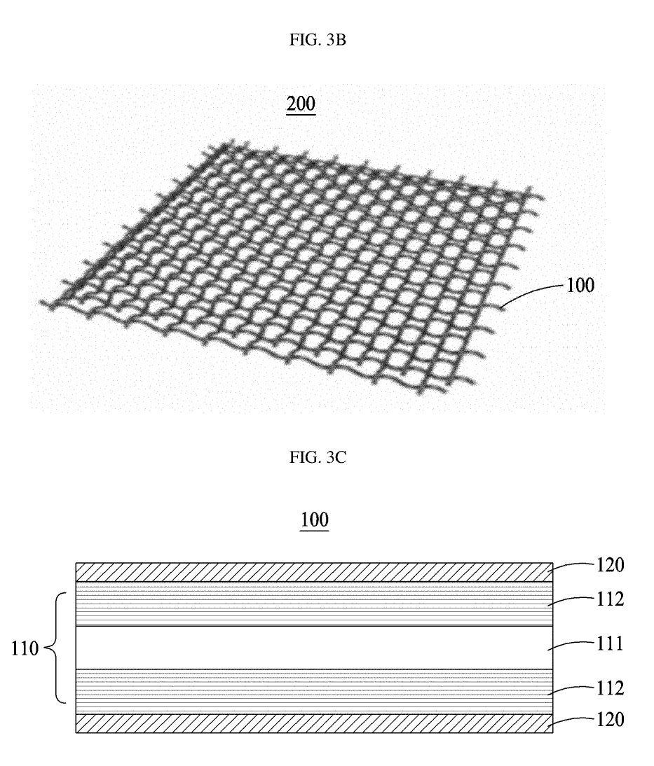

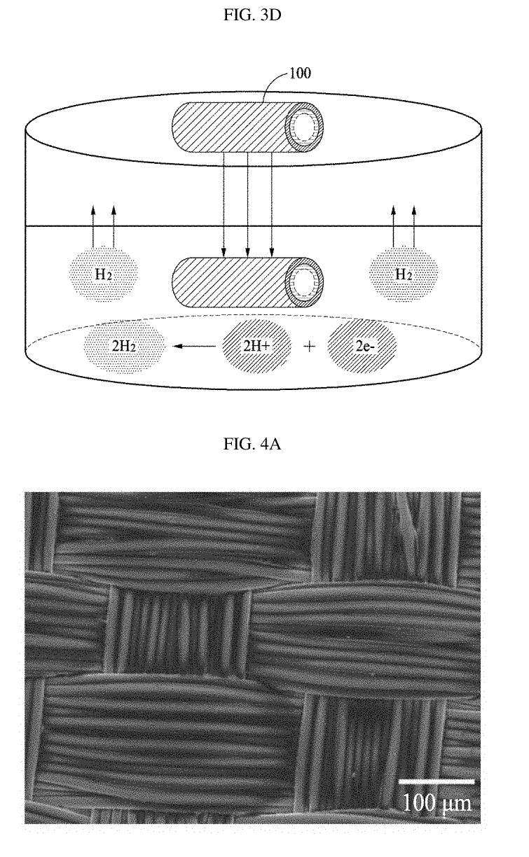

Hereinafter, referring to FIGS. 3A to 3D, the catalyst for generating hydrogen according to an embodiment of the present disclosure is described.

A catalyst for generating hydrogen 100 includes a conductive textile 110 and a transition metal chalcogen compound thin film 120 formed on the conductive textile 110, wherein the conductive textile 110 is composed of a polymer fiber 111 and a metal film 112, and the surface of the polymer fiber 111 is coated with the metal film 112.

The catalyst for generating hydrogen 100 according to an embodiment of the present disclosure has been described in the description of FIG. 1. Therefore, description of overlapping components is omitted.

FIG. 3A is an image illustrating the shape of the catalyst for generating hydrogen according to an embodiment of the present disclosure.

The catalyst for generating hydrogen 100 according to an embodiment of the present disclosure may be formed in a cylindrical shape.

Preferably, the catalyst for generating hydrogen 100 according to an embodiment of the present disclosure may, without being limited to, have a cylindrical shape, in which the conductive textile 110 composed of the polymer fiber 111 and the metal film 112 is in the center, and the transition metal chalcogen compound thin film 120 is formed on the conductive textile 110. At this time, the surface of the polymer fiber 111 is coated with the metal film 112.

When the catalyst for generating hydrogen 100 according to an embodiment of the present disclosure has a cylindrical shape, the surface area of the catalyst for generating hydrogen increases, and, consequently, the characteristics of the catalyst may be improved.

FIG. 3B is a drawing illustrating a three-dimensional catalyst for generating hydrogen according to an embodiment of the present disclosure.

The catalyst for generating hydrogen 100 according to an embodiment of the present disclosure may be formed in a three-dimensional shape.

Referring to FIG. 3B, the catalyst for generating hydrogen 100 according to an embodiment of the present disclosure may form a three-dimensional catalyst for generating hydrogen 200, in which a transition metal chalcogen compound thin film is formed on a textile fiber having a net-shaped entangled form.

Since the three-dimensional catalyst for generating hydrogen 200 according to an embodiment of the present disclosure is formed in the form of a net in which several strands of the catalyst for generating hydrogen 100 are intertwined, the area to volume ratio of the three-dimensional catalyst for generating hydrogen 200 further increases, and, consequently, a hydrogen generation reaction area may be maximized.

FIG. 3C is an image illustrating the cross section of the catalyst for generating hydrogen according to an embodiment of the present disclosure.

The catalyst for generating hydrogen 100 according to an embodiment of the present disclosure includes the transition metal chalcogen compound thin film 120 formed on the conductive textile 110.

In addition, the conductive textile 110 is composed of the polymer fiber 111 and the metal film 112, and the surface of the polymer fiber 111 is coated with the metal film 112.

As the polymer fiber 111, polyester may be used, without being limited thereto.

As the metal film 112, nickel (Ni), copper (Co) and tin (Sn) may be used, without being limited thereto.

As the conductive textile 110 according to an embodiment of the present disclosure, an electromagnetic wave shielding material may be used, without being limited thereto.

The transition metal chalcogen compound thin film 120, which is formed on the conductive textile 110, may be formed by atomic layer deposition using a hydrogen sulfide (H₂S) chalcogen precursor and a Co(AMD)₂ transition metal precursor.

Therefore, a catalyst for generating hydrogen, in which the transition metal chalcogen compound thin film 120 containing cobalt sulfide (CoS) is formed on the conductive textile 110, may be prepared.

Since the catalyst for generating hydrogen 100 according to an embodiment of the present disclosure includes the conductive textile 110 and the transition metal chalcogen compound thin film 120 formed on the conductive textile 110, a Tafel slope is small, such that the activity of the catalyst is improved and, consequently, the stability of the catalyst may be improved when hydrogen is generated.

Since the catalyst for generating hydrogen 100 according to an embodiment of the present disclosure has a low onset potential, hydrogen generation reaction starts at low voltage, and, consequently, hydrogen may be generated at low electric power.

Since the catalyst for generating hydrogen 100 according to an embodiment of the present disclosure has a high exchange current density, a large number of electrons is transferred, and, consequently, the amount of hydrogen generation may be increased.

FIG. 3D is an image illustrating a water-splitting reaction using the catalyst for generating hydrogen according to an embodiment of the present disclosure.

The catalyst for generating hydrogen 100 according to an embodiment of the present disclosure may be used in many fields such as water splitting, hydrogen generation, batteries and super capacitors.

Preferably, the catalyst for generating hydrogen 100 may be used in water splitting, and referring to FIG. 3D, the technology of using the catalyst for generating hydrogen 100 according to an embodiment of the present disclosure for water splitting is described.

The catalyst for generating hydrogen 100 according to an embodiment of the present disclosure may generate hydrogen using electrochemical oxidation/reduction.

Referring to FIG. 3C, the catalyst for generating hydrogen 100 is added to a storage container containing water (H₂O), and then water reacts with the catalyst for generating hydrogen 100 to generate hydrogen (H₂).

The catalyst for generating hydrogen 100 transfers electrons received from a conductive textile to adsorbed hydrogen to generate hydrogen.

At this time, the conductive textile of the catalyst for generating hydrogen 100 is used as a substrate for transferring electrons, and a transition metal chalcogen compound thin film lowers hydrogen adsorption energy, thereby improving the adhesion of hydrogen and hydrogen ions to the catalyst for generating hydrogen 100.

The catalyst for generating hydrogen 100 according to an embodiment of the present disclosure rapidly transfers electrons to reduce H⁺ in the water to H₂. Hydrogen generation reaction is as follows:

2H⁺+2e−→H₂ Reaction Formula

In addition, the catalyst for generating hydrogen 100 according to an embodiment of the present disclosure promotes activation of surrounding molecules, by which water splitting reaction may be continuously and repeatedly promoted.

### PREPARATION EXAMPLES

### Comparative Example

As a catalyst for generating hydrogen, platinum (Pt) is used.

### Examples

A process cycle composed of a step of simultaneously injecting Co(AMD)₂ and argon (Ar) heated to 90° C. at a flow rate of 50 SCCM (Standard Cubic Centimeter per Minute) onto a conductive textile (W-290-PCS), a step of injecting argon (Ar) at a flow rate of 50 SCCM, a step of injecting H₂S at a flow rate of 10 SCCM, and a step of injecting argon (Ar) at a flow rate of 50 SCCM was performed at 100° C.

A transition metal chalcogen compound thin film of cobalt sulfide was formed by atomic layer deposition performed by repeating the above-described process cycle 100 times.

W-290-PCS (Ajin Electron, Korea) in which nickel (Ni), copper (Cu) and tin (Sn) were sequentially formed on a polyester was used as the conductive textile.

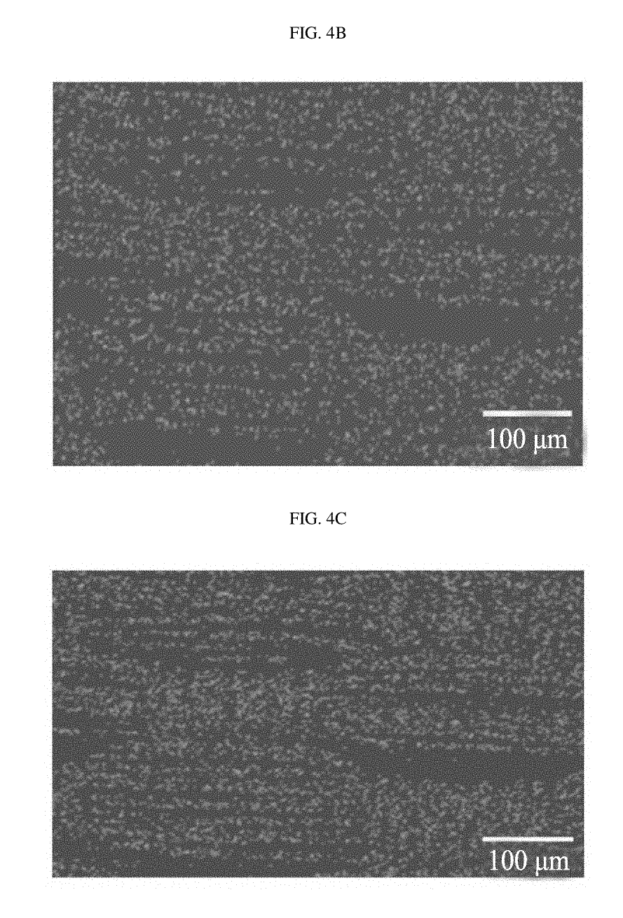

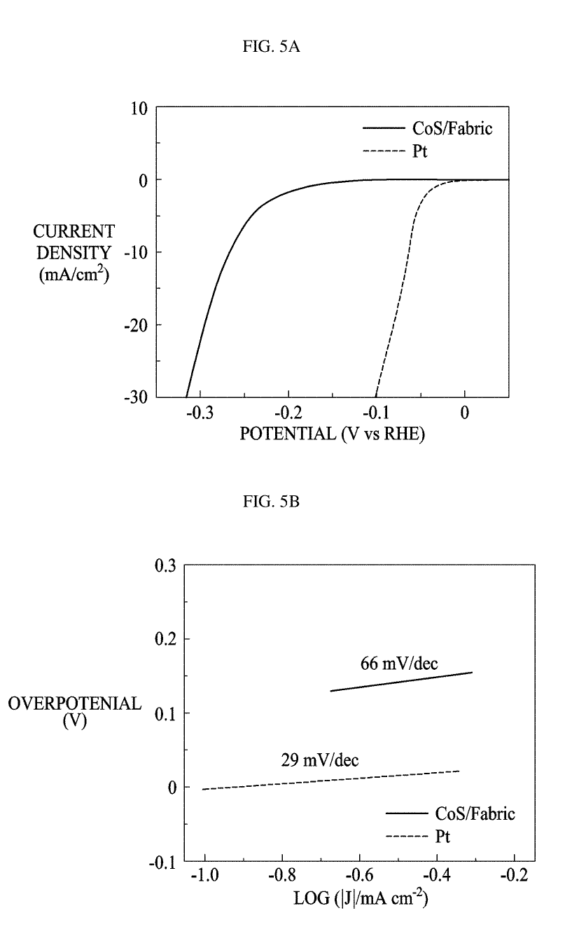

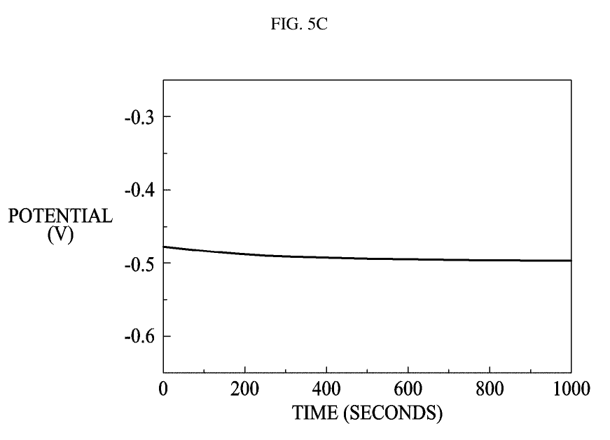

Hereinafter, referring to FIGS. 4A to 5C, the catalytic characteristics of a catalyst for generating hydrogen according to an embodiment of the present disclosure are described.

FIGS. 4A to 4C are the images of a catalyst for generating hydrogen according to an embodiment of the present disclosure obtained using a scanning electron microscope (SEM) and energy-dispersive X-ray spectroscopy (EDS).

FIG. 4A is the scanning electron microscope (SEM) image of the catalyst for generating hydrogen according to an embodiment of the present disclosure, and FIGS. 4B and 4C are the energy-dispersive X-ray spectroscopy (EDS) images of the catalyst of generating hydrogen.

FIG. 4B represents the Co L Series of cobalt (Co) included in a chalcogen compound thin film (cobalt sulfide) according to an embodiment of the present disclosure, and FIG. 4C represents the S K series of sulfur (S).

Energy-dispersive X-ray spectroscopy (EDS) is a method of detecting the energy function of a specific X-ray represented by each element and displaying a portion where each element is located.

In an element, the energy generated from each electron shell varies, and the energy generated from the K shell, the L shell, and the M shell is referred to as K Series, L Series, and M Series, respectively.

Referring to FIGS. 4A to 4C, it can be confirmed that cobalt (Co) and sulfur (S) are uniformly formed on a conductive textile according to an embodiment of the present disclosure.

FIGS. 5A to 5C are graphs illustrating the catalytic characteristics of a catalyst for generating hydrogen according to an embodiment of the present disclosure.

FIG. 5A is a graph showing the current density (mA/cm²) of the catalyst for generating hydrogen according to an embodiment of the present disclosure depending on a potential change (V vs. RHE), and FIG. 5B is a graph showing overpotential (V) according to a change in the log value of current density, log(|J|mAcm⁻²), and FIG. 5C is a graph showing potential (V) according to time (seconds) change.

Referring to FIG. 5A, as shown in the polarization curves of FIG. 5A, a catalyst for generating hydrogen of a comparative example (Pt) exhibits an onset potential of −0.1 V, whereas a catalyst for generating hydrogen according to an example (CoS/Fabric) of the present disclosure exhibits an onset potential of −0.3 V. Thus, compared to the comparative example (Pt), the catalyst according to the example (CoS/Fabric) has a very low onset potential.

Therefore, since the catalyst for generating hydrogen (CoS/Fabric) according to an example of the present disclosure has a very low onset potential of −0.15 V or less, hydrogen generation reaction starts at low voltage, and, consequently, hydrogen may be generated at low electric power.

FIG. 5B is a Tafel plot showing Tafel slopes obtained by converting the values of FIG. 5A.

The unit of a Tafel slope, mV/dec, refers to mV/decade, and a Tafel slope represents a value obtained by dividing overpotential, i.e., a difference between applied potential and potential required for reaction, by log current density.

In addition, a Tafel slope is a value determined by the transfer coefficient of a reaction and the number of transferred electrons, and varies greatly depending on the reversibility of a reaction or the number of electrons involved in a reaction.

Referring to FIG. 5B, the Tafel slope of the catalyst for generating hydrogen (CoS/Fabric) according to an example of the present disclosure has a value of 66 mV/dec or less, whereas the Tafel slope of the catalyst for generating hydrogen according to the comparative example (Pt) has a value of 29 mV/dec or less.

Although the catalyst for generating hydrogen (CoS/Fabric) according to an example of the present disclosure has a high Tafel slope value relative to the catalyst for generating hydrogen according to the comparative example (Pt), in the case of the catalyst for generating hydrogen according to the comparative example (Pt), expensive platinum is used, leading to an increase in cost.

However, since the catalyst for generating hydrogen (CoS/Fabric) according to an example of the present disclosure has a low Tafel slope value and expensive platinum is not used in the preparation of the catalyst for generating hydrogen (CoS/Fabric), cost is reduced and the catalyst for generating hydrogen (CoS/Fabric) may have an effect equivalent to the catalyst for generating hydrogen according to the comparative example (Pt).

Therefore, the catalyst for generating hydrogen according to the comparative example (Pt) may be replaced with the catalyst for generating hydrogen (CoS/Fabric) according to an example of the present disclosure.

FIG. 5C is a graph showing the potential of the catalyst for generating hydrogen according to an embodiment of the present disclosure.

Referring to FIG. 5C, the potential of the catalyst for generating hydrogen according to an example of the present disclosure does not change to 15 minutes (900 seconds), indicating that the catalyst for generating hydrogen according to an example of the present disclosure is very stable.

Since the catalyst for generating hydrogen according to an embodiment of the present disclosure includes a conductive textile and a transition metal chalcogen compound thin film, a Tafel slope is small, such that the activity of the catalyst is improved and, consequently, the stability of the catalyst can be improved when hydrogen is generated.

Since the catalyst for generating hydrogen according to an embodiment of the present disclosure has a low onset potential, hydrogen generation reaction starts at low voltage, and, consequently, hydrogen can be generated at low electric power. In addition, since the catalyst for generating hydrogen has a high exchange current density, a large number of electrons is transferred, and, consequently, the amount of hydrogen generation can be increased.

Since a conductive textile is used in the preparation of the catalyst for generating hydrogen according to an embodiment of the present disclosure, the catalyst for generating hydrogen can be applied to a flexible or wearable device.

In the catalyst for generating hydrogen according to an embodiment of the present disclosure, since the transition metal chalcogen compound thin film is formed using atomic layer deposition, the thickness of the transition metal chalcogen compound thin film can be finely adjusted, and the characteristics of the catalyst for generating hydrogen can be precisely analyzed. In addition, the transition metal chalcogen compound thin film can be uniformly formed over a large area, and the amount of hydrogen generation can be increased due to an increase in a reaction zone for hydrogen generation reaction.

Although the present disclosure has been described through limited examples and figures, the present disclosure is not intended to be limited to the examples. Those skilled in the art will appreciate that various modifications, additions and substitutions are possible, without departing from the scope and spirit of the disclosure.

Therefore, the scope of the present disclosure should not be limited to the described embodiments, but should be determined by the equivalents of the claims, as well as the following claims.

What is claimed is:

1. A catalyst for generating hydrogen, comprising:
a conductive textile; and
a transition metal chalcogen compound thin film formed on the conductive textile,
wherein the conductive textile is composed of a polymer fiber and a metal film, and the surface of the polymer fiber is coated with the metal film.

2. The catalyst for generating hydrogen according to claim 1, wherein the polymer fiber is at least any one selected from the group consisting of polyester, aramid, polystyrene, polyvinyl chloride, acrylonitrile-butadiene-styrene terpolymer, polyethylene, acrylic resin, nylon and polyacetal resin.

3. The catalyst for generating hydrogen according to claim 1, wherein the metal film comprises at least any one selected from the group consisting of nickel (Ni), copper (Cu), tin (Sn), gold (Au), silver (Ag), platinum (Pt), aluminum (Al), titanium (Ti), chromium (Cr), palladium (Pd), molybdenum (Mo), cobalt (Co), tungsten (W), iron (Fe) and zinc (Zn).

4. The catalyst for generating hydrogen according to claim 1, wherein the transition metal chalcogen compound thin film comprises cobalt sulfide (CoS).

5. A method of preparing a catalyst for generating hydrogen, the method comprising:
preparing a conductive textile by coating a surface of a polymer fiber with a metal film; and
forming a transition metal chalcogen compound thin film on the conductive textile using chalcogen and transition metal precursors.

6. The method according to claim 5, wherein the chalcogen precursor comprises hydrogen sulfide (H₂S).

7. The method according to claim 5, wherein the transition metal precursor comprises Co(AMD)₂(bis(N,N′-diisopropylacetamidinato).

8. The method according to claim 5, wherein the transition metal chalcogen compound thin film is formed by atomic layer deposition (ALD).

9. The method according to claim 5, wherein the transition metal chalcogen compound thin film is formed at a temperature of 80 to 200° C.
